(19) United States
(12) Patent Application Publication
(10) Pub. No.: US 2026/0289940 A1
(43) Pub. Date: Sep. 24, 2026

(54) OBJECT DETECTION AND RECOGNITION USING VISUAL, TEXTUAL, AND SEMANTIC FEATURES

(71) Applicant: Infosys Limited, Bangalore (IN)

(72) Inventors: Ramjee Rajasekaran, Bengaluru (IN); Sidharth Subhash Ghag, Pune (IN); Gomathy Sankaran K, Bengaluru (IN)

(73) Assignee: Infosys Limited, Bangalore (IN)

(21) Appl. No.: 19/094,297

(22) Filed: Mar. 28, 2025

(30) Foreign Application Priority Data
Mar. 20, 2025 (IN) 202541025182

(51) Int. Cl. G06V 10/25; G06V 10/44; G06V 10/56; G06V 10/74

(52) U.S. Cl. CPC G06V 10/25; G06V 10/44; G06V 10/56; G06V 10/761; G06V 2201/07

(57) ABSTRACT

Object detection and recognition using visual, textual, and semantic features is provided in the present disclosure. In an image, a bounding box representing an object is detected using a prompt-based object detection model. Further, an object description indicative of an appearance of the object is generated using an image-to-text model. Based on the bounding box and the object description, a current feature profile is generated for the object. The current feature profile indicates appearance characteristics of the object. The current feature profile is compared with reference feature profiles stored in a database, and a profile similarity score is assigned to each reference feature profile. The profile similarity score indicates a similarity between the current feature profile and the corresponding reference feature profile. One reference object is then selected, the selected reference object being associated with the reference feature profile having the highest profile similarity score.

### FIELD OF THE DISCLOSURE

Various embodiments of the present disclosure relate generally to image processing. More specifically, various embodiments of the present disclosure relate to object detection and recognition using visual, textual, and semantic features.

### BACKGROUND

In large facilities (e.g., retail stores, warehouses, or the like), object identification, localization, and classification are necessary for smooth functioning. Traditionally, these tasks have relied heavily on human operators, such as crew members, who had to manually inspect images, videos, or physical environments to identify, localize, classify, and catalog various products. However, this manual approach is not only labor-intensive and prone to fatigue but also susceptible to errors and inconsistencies. Further, the shortcomings of the human-driven approach are exacerbated for large data volumes.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for object detection and recognition using visual, textual, and semantic features are provided substantially as shown in, and described in connection with, at least one of the figures.

The systems disclosed herein include processing circuitry. The processing circuitry is configured to detect, in an image, using a prompt-based object detection model, a target bounding box representing a target object present in the image. Based on the target bounding box, the processing circuitry is further configured to generate, using an image-to-text model, an object description indicative of an appearance of the target object. Based on the target bounding box and the object description, the processing circuitry is further configured to generate a current feature profile of the target object. The current feature profile is indicative of a plurality of appearance characteristics of the target object. The processing circuitry is further configured to compare the current feature profile of the target object with a plurality of reference feature profiles of a plurality of reference objects. Further, the processing circuitry is configured to select one of the plurality of reference objects that matches the target object. A similarity between the current feature profile of the target object and a reference feature profile of the selected reference object is within a desired range.

In some embodiments, to detect the target bounding box in the image, the processing circuitry is further configured to receive the image, obtain a prompt indicative of the detection of the target object in the image, and process, using the prompt-based object detection model, the image based on the prompt to detect the target bounding box.

In some embodiments, the prompt indicates at least one of: a name, a type, a material, a dimension, one or more packaging details, or one or more manufacturing details of the target object.

In some embodiments, the current feature profile of the target object comprises at least one of a feature vector, an image embedding vector, and a text embedding vector. The feature vector indicates a set of visual features of the target object. The image embedding vector is generated using the target bounding box. Further, the text embedding vector corresponds to a vector representation of the object description.

In some embodiments, the processing circuitry is further configured to extract the set of visual features from the object description. The set of visual features comprises at least one of a color, a shape, one or more text labels, a packaging attribute, or a texture associated with the target object.

In some embodiments, the processing circuitry is further configured to process the target bounding box using an image feature extraction model to generate the image embedding vector.

In some embodiments, the processing circuitry is further configured to process the object description using a text embedding model to generate the text embedding vector.

In some embodiments, to compare the current feature profile of the target object with a first reference feature profile, of the plurality of reference feature profiles, representing a first reference object, of the plurality of reference objects, the processing circuitry is further configured to compare the feature vector associated with the target object with another feature vector generated for the first reference object, compare the image embedding vector associated with the target object with another image embedding vector generated for the first reference object, and compare the text embedding vector associated with the target object with another text embedding vector generated for the first reference object.

In some embodiments, based on the comparison of the current feature profile with the first reference feature profile, the processing circuitry is further configured to generate a profile similarity score for the first reference feature profile of the first reference object. The profile similarity score is indicative of the similarity between the current feature profile and the first reference feature profile. The processing circuitry selects one of the plurality of reference objects that matches the target object based on a plurality of profile similarity scores of the plurality of reference feature profiles.

In some embodiments, to generate the profile similarity score, the processing circuitry is further configured to generate a visual feature similarity score, an image embedding similarity score, and a text embedding similarity score. The visual feature similarity score is indicative of a similarity between the feature vector associated with the target object and the feature vector generated for the first reference object. The image embedding similarity score is indicative of a similarity between the image embedding vector associated with the target object and the image embedding vector generated for the first reference object. The text embedding similarity score is indicative of a similarity between the text embedding vector associated with the target object and the text embedding vector generated for the first reference object. The processing circuitry is further configured to assign a weight to each of the visual feature similarity score, the image embedding similarity score, and the text embedding similarity score. The profile similarity score is a function of the visual feature similarity score, the weight assigned to the visual feature similarity score, the image embedding similarity score, the weight assigned to the image embedding similarity score, the text embedding similarity score, and the weight assigned to the text embedding similarity score.

In some embodiments, the processing circuitry detects the target bounding box based on a prompt. The processing circuitry assigns the weight to each of the visual feature similarity score, the image embedding similarity score, and the text embedding similarity score based on the prompt.

In some embodiments, the weight assigned to each of the visual feature similarity score, the image embedding similarity score, and the text embedding similarity score is static.

In some embodiments, to generate the visual feature similarity score, the processing circuitry is further configured to generate a set of intermediate scores and assign a set of intermediate weights to the set of intermediate scores. Each intermediate score indicates a similarity between one visual feature associated with the target object and the first reference object. The visual feature similarity score is a function of each intermediate score of the set of intermediate scores and an intermediate weight, of the set of intermediate weights, assigned to the corresponding intermediate score.

In some embodiments, the system further comprises a storage element configured to store a database. The database includes a mapping between a descriptor of each of the plurality of reference objects and a reference feature profile, of the plurality of reference feature profiles, generated for the corresponding reference object of the plurality of reference objects. The processing circuitry is coupled to the storage element, and configured to access the storage element to compare the current feature profile of the target object with the plurality of reference feature profiles of the plurality of reference objects.

In some embodiments, the processing circuitry is further configured to generate, based on the comparison of the current feature profile with the plurality of reference feature profiles, a plurality of profile similarity scores for the plurality of reference feature profiles. Each profile similarity score, of the plurality of profile similarity scores, is indicative of a similarity between the current feature profile and a corresponding reference feature profile of the plurality of reference feature profiles. The selected reference object is associated with the reference feature profile having the highest profile similarity score among the plurality of profile similarity scores.

In some embodiments, the processing circuitry is further configured to determine, based on the plurality of profile similarity scores, a set of reference feature profiles. The profile similarity score of each of the set of reference feature profiles is within the desired range. The processing circuitry is further configured to refine a set of profile similarity scores associated with the set of reference feature profiles based on a prompt using which the target bounding box is detected and a set of reference object descriptions associated with a set of reference objects represented by the set of reference feature profiles. The selected reference object is associated with the reference feature profile having the highest profile similarity score among the refined set of profile similarity scores.

In some embodiments, the processing circuitry refines each of the set of profile similarity scores using a cross-encoder re-ranking model.

In some embodiments, the processing circuitry is further configured to render a user interface representing the image, with the target bounding box. The target bounding box is labeled with a descriptor associated with the selected reference object.

In some embodiments, the plurality of reference feature profiles include two or more reference feature profiles generated for a same reference object, with the two or more reference feature profiles generated based on two or more images of the corresponding reference object, respectively.

In another embodiment of the present disclosure, a method is disclosed. The method comprises detecting, by processing circuitry, in an image, using a prompt-based object detection model, a target bounding box representing a target object present in the image. The method further comprises generating, by the processing circuitry, based on the target bounding box, using an image-to-text model, an object description indicative of an appearance of the target object. Further, the method comprises generating, by the processing circuitry, based on the target bounding box and the object description, a current feature profile of the target object. The current feature profile is indicative of a plurality of appearance characteristics of the target object. The method further comprises comparing, by the processing circuitry, the current feature profile of the target object with a plurality of reference feature profiles of a plurality of reference objects. The method further comprises selecting, by the processing circuitry, one of the plurality of reference objects that matches the target object. A similarity between the current feature profile of the target object and a reference feature profile of the selected reference object is within a desired range.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an object detection and recognition environment, consistent with disclosed embodiments of the present disclosure;

FIG. 2 is a block diagram of processing circuitry of the object detection and recognition environment of FIG. 1, consistent with disclosed embodiments of the present disclosure;

FIG. 3A and 3B, collectively, represents an example scenario of an object detection and recognition technique, consistent with disclosed embodiments of the present disclosure;

FIGS. 4A and 4B, collectively, represents a flowchart that illustrates a method for object detection and recognition, consistent with disclosed embodiments of the present disclosure; and

FIG. 5 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to alleviate the shortcomings of human-driven object identification, localization, and classification approaches, object detection and recognition models may be employed. These models leverage advanced machine learning and image processing techniques to process images or video frames, identify multiple objects within an image or a video, draw bounding boxes around them, and classify detected objects, assigning labels based on trained categories to understand what each object represents. Examples of object detection models include You Only Look Once (YOLO), Faster Region-Based Convolutional Neural Network (R-CNN), or the like, whereas, examples of object recognition models include Residual Networks (ResNet), Visual Geometry Group Network, or the like. The accuracy of these models relies on the quality of the model training. These models are typically trained using large datasets of annotated data (e.g., labeled images), where the models learn patterns, features, and object boundaries through iterative optimization using techniques like backpropagation and loss minimization.

Thus, vast amounts of annotated data are required for accurate product identification, localization, and recognition, which may be labor-intensive and time-consuming to collect – particularly in dynamic environments such as retail shelves where products frequently change. The processing of such vast amounts of training data increases the computational power required for these models. Further, in some scenarios, collecting such vast amounts of training data may not even be feasible. This may delay or halt the deployment of these models in real-world applications. Additionally, if the product class changes, which is quite common in dynamic environments such as retail stores, warehouses, or the like, these models have to be retrained on the new classes, leading to a further increase in the computational load. Additionally, the training data only includes visual features of the objects. The trained models may thus not be effective and accurate in varied settings (e.g., occlusion, change in illumination, background clutter, or the like).

The present disclosure addresses the above limitations by providing a system and a method that uses visual, textual, and semantic features for object detection and recognition. In the present disclosure, a bounding box is detected in an input image using a prompt-based object detection model. The bounding box may represent an object present in the input image. The prompt-based object detection model may be utilized to generate bounding boxes based on a prompt that indicates a name, a type, a material, a dimension, one or more packaging details, or one or more manufacturing details of the object. Based on the bounding box, an object description, indicative of the appearance of the object, is generated using an image-to-text model. Further, based on the bounding box and the object description, a current feature profile is generated for the object. The current feature profile may indicate various appearance characteristics of the object. For example, the current feature profile may include a feature vector that indicates various visual features of the object, an image embedding vector generated using the bounding box and an image feature extraction model, and a text embedding vector corresponding to a vector representation of the object description.

The current feature profile is then compared with reference feature profiles stored in a database. Based on the comparison, a profile similarity score is assigned to each reference feature profile, the profile similarity score indicating a similarity between the current feature profile and the corresponding reference feature profile. The reference feature profiles having profile similarity scores in a desired range are determined. The profile similarity scores of these profiles are then refined based on the prompt and object descriptions associated with reference objects represented by these reference feature profiles. The profile similarity scores may be refined using a cross-encoder re-ranking mechanism. One reference object is then selected, the selected reference object being associated with the reference feature profile having the highest profile similarity score among the refined profile similarity scores. The selected reference object is thus indicative of (e.g., matches) the object detected in the input image.

In the present disclosure, the reference feature profiles are generated for various reference objects using a handful of images (e.g., five images) of each reference object. Additionally, during detection, the prompt-based bounding box detection approach eliminates the need for extensive iterative model training. Thus, the object detection and recognition technique of present disclosure may be executed without requiring vast amounts of annotated data. As a result, the object detection and recognition technique of the present disclosure is less labor-intensive and time-consuming as compared to conventional object detection and recognition models that are trained on vast amounts of labeled images. Consequently, the computational power utilized by the object detection and recognition technique of the present disclosure is also less as compared to the conventional object detection and recognition models. Further, the real-world deployment may be made quicker and more cost-effective. As vast amounts of labeled images are not required for effective operation, the object detection and recognition technique of the present disclosure is highly effective in dynamic environments like retail stores, warehouses, or the like. Additionally, modification or addition of new product classes does not necessitate any model retraining, saving significant computational power.

In the present disclosure, text embeddings and image embeddings are utilized, in addition to the visual features, for object detection and recognition. The detection accuracy of the object detection and recognition technique of the present disclosure is thus higher than the conventional object detection and recognition models that utilize only the visual cues. Further, the use of more than just visual features ensures that the technique of the present disclosure may be implemented in varied settings (e.g., occlusion, change in illumination, background clutter, or the like). The accuracy may be further enhanced through the cross-encoder re-ranking mechanism, ensuring that the most contextually relevant product is selected from the top-ranked results. This refinement process may thus significantly improve object recognition, addressing a limitation often seen in conventional models that depend solely on initial ranking. The object detection and recognition technique of the present disclosure may thus be highly suitable for real-time applications, ensuring precise and efficient object identification in fast-paced environments. It is appreciated that the human mind is not equipped to conceptualize and engineer accurate, effective, and dynamic object detection and recognition using visual, textual, and semantic features, given the digital interconnectedness of such object detection and recognition.

### Figure Description

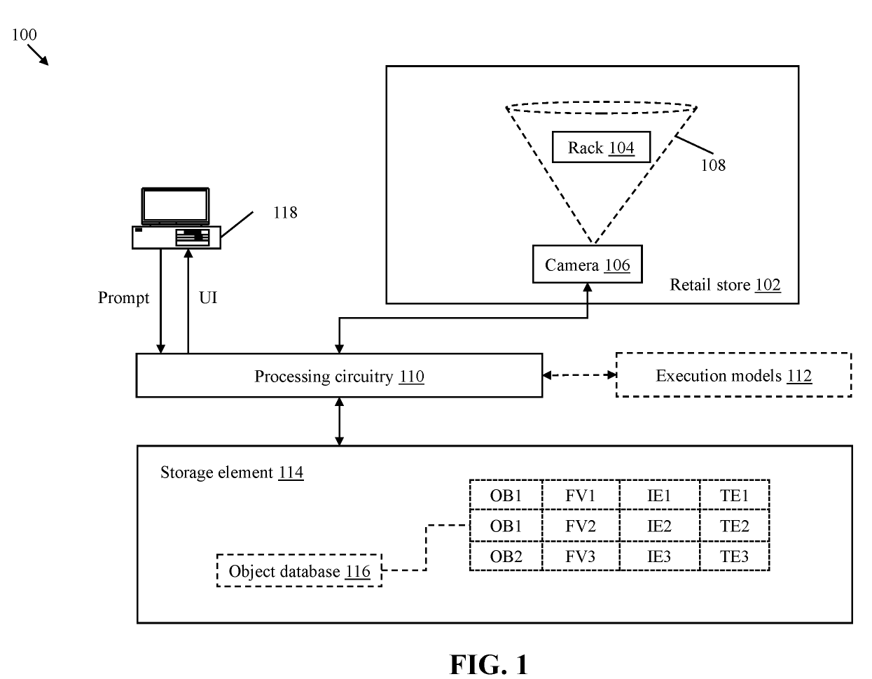

FIG. 1 is a schematic diagram that illustrates an object detection and recognition environment 100, consistent with disclosed embodiments of the present disclosure. The object detection and recognition environment 100 (hereinafter referred to as the “environment 100”) includes a retail store 102. The retail store 102 may include a plurality of racks, of which a rack 104 is shown. The rack 104 may have various shelves for displaying objects (e.g., products). The products on the rack 104 may be of different brands and types. In an embodiment, the products may be arranged on the rack 104 in groups of the same brands or product types.

The retail store 102 may include an image-capturing unit 106 that is positioned in close proximity to the rack 104 to capture an image of the rack 104 (e.g., various objects placed on the rack 104). In an example, the image-capturing unit 106 is placed at a distance of 1 meter from the rack 104. However, in other embodiments, the distance between the rack 104 and the image-capturing unit 106 may be different. In an embodiment, the image-capturing unit 106 may correspond to a camera. The image-capturing unit 106 (hereinafter referred to as the “camera 106”) has a field-of-view (FOV) 108 that defines the extent of the observable scene captured by the lens. In other words, the camera 106 may be configured to continuously capture a video of the associated FOV 108. The placement of the camera 106 may be such that the rack 104 is within the FOV 108.

In large facilities (such as the retail store 102), object identification, localization, and classification are necessary for efficient operations. Traditionally, these tasks were performed manually by human operators, who inspected images, videos, or physical environments to recognize and catalog products. However, this manual approach is labor-intensive, prone to errors, and inefficient, especially when dealing with large volumes of data. To address these limitations, machine learning (ML)-based object detection and recognition models have been developed. These models use advanced image processing techniques to detect objects in images captured by cameras, draw bounding boxes, and classify them based on trained categories, significantly improving accuracy and efficiency.

Despite their advantages, these models require large datasets of annotated images for effective training, which is time-consuming and computationally demanding. In dynamic environments like retail stores, where product inventories frequently change, collecting and labeling vast amounts of training data may be impractical. Additionally, whenever new product categories are introduced, models need to be retrained, further increasing computational costs. These models primarily rely on visual features, making them susceptible to challenges such as occlusion, lighting variations, and background clutter, which may reduce their accuracy in real-world settings.

To overcome these challenges, an object detection and recognition technique that utilizes visual, textual, and semantic features of objects (e.g., products) is disclosed in the present disclosure. To facilitate such an object detection and recognition technique, the environment 100 may further include processing circuitry 110, execution models 112, and a storage element 114. The processing circuitry 110, the execution models 112, and the storage element 114 may collectively execute the object detection and recognition technique of the present disclosure. The object detection and recognition technique of the present disclosure is utilized to process an image of the rack 104 to detect various objects present thereon, and identify a known label for each detected object using visual, textual, and semantic features of the objects.

The processing circuitry 110 may be coupled to the camera 106 and the storage element 114. The processing circuitry 110 may include suitable logic, circuitry, interfaces, and/or code, executable by the circuitry, that may be configured to execute the object detection and recognition technique in the retail store 102.

### Reference feature profile creation

The processing circuitry 110 may be configured to receive multiple images of various reference objects (e.g., products) that are likely to be present in a rack (e.g., the rack 104) of the retail store 102. In an embodiment, for effective object detection and recognition, five images are used for each reference object. For each image, the processing circuitry 110 may be configured to generate a reference feature profile indicative of appearance characteristics of the reference object present in the image.

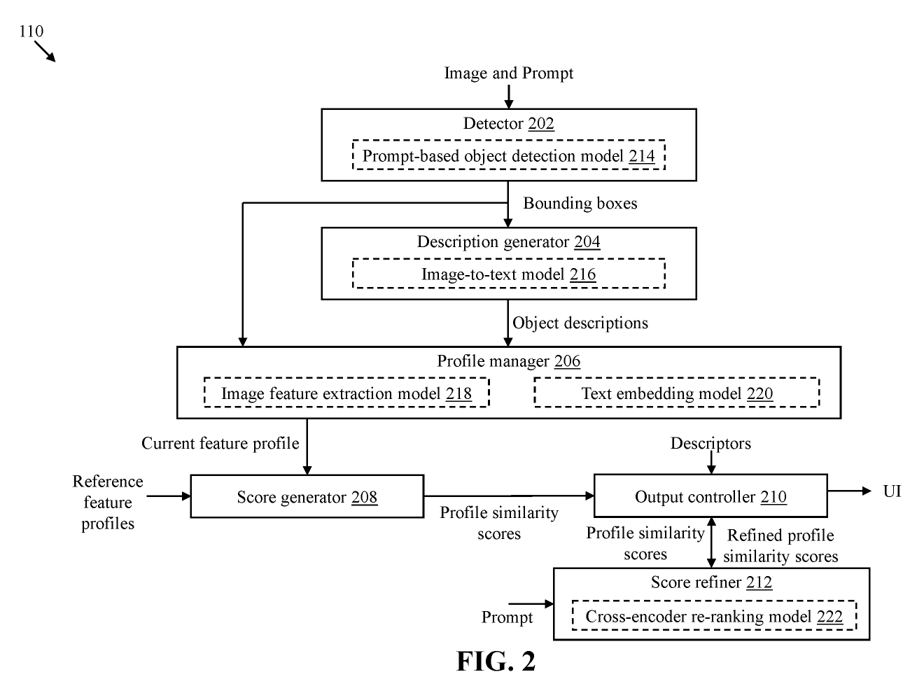

To generate a first reference feature profile using a first reference image of a first reference object, the processing circuitry 110 may execute various operations. For example, the processing circuitry 110 may be configured to process the first reference image and detect a reference bounding box representing the first reference object. Based on the first reference bounding box, the processing circuitry 110 may be further configured to generate a first reference object description indicative of an appearance of the first reference object. The processing circuitry 110 may generate the first reference object description using at least one of the execution models 112. The execution models 112 may include various artificial intelligence (AI) models that are utilized by the processing circuitry 110 for the execution of the object detection and recognition technique of the present disclosure. For the generation of the first reference object description, the execution models 112 may include an image-to-text model. In an example, the image-to-text model may correspond to a vision-language model (VLM) such as Phi-3. The image-to-text model is explained in detail in FIG. 2. Based on the first reference bounding box and the first reference object description, the processing circuitry 110 may be further configured to generate the first reference feature profile.

In an embodiment, the processing circuitry 110 may be further configured to extract a first reference set of visual features from the first reference object description and generate a first reference feature vector that indicates the first reference set of visual features of the first reference object. The first reference set of visual features may include at least one of a color, a shape, one or more text labels, a packaging attribute, or a texture associated with the target object. However, in other embodiments, different visual features may be utilized. Further, the processing circuitry 110 may be configured to process the first reference bounding box using one of the execution models 112 to generate a first reference image embedding vector of the first reference object. In such a scenario, the execution models 112 may include an image feature extraction model. In an example, the image feature extraction model may correspond to a VLM such as contrastive language-image pretraining (CLIP). Further, the processing circuitry 110 may be configured to process the first reference object description using one of the execution models 112 to generate a first reference text embedding vector of the first reference object. In such a scenario, the execution models 112 may include a text embedding model. In an example, the text embedding model may correspond to a VLM such as CLIP. The image feature extraction model and the text embedding model are explained in detail in FIG. 2.

The first reference feature profile of the first reference object thus includes the first reference feature vector, the first reference image embedding vector, and the first reference text embedding vector. The processing circuitry 110 may be further configured to generate a mapping between a descriptor of the first reference object and the first reference feature profile (e.g., the first reference feature vector, the first reference image embedding vector, and the first reference text embedding vector) generated for the first reference object. The descriptor of the first reference object may correspond to a name, a type, a brand, or the like, of the first reference object.

The processing circuitry 110 may be further configured to store the generated mapping in the storage element 114. The storage element 114 may correspond to a hardware storage (for example, hard drive, solid-state drive, or the like) or a cloud storage (for example, cloud services). The storage element 114 may be configured to store an object database 116 that includes the generated mapping. The object database 116 may thus be configured to store the mapping between a descriptor of a reference object and a reference feature profile generated for the corresponding reference object. As illustrated in FIG. 1, the object database 116 may be configured to store the mapping between a first descriptor (denoted as “OB1”) of the first reference object, the first reference feature vector (denoted as “FV1”) of the first reference object, the first reference image embedding vector (denoted as “IE1”) of the first reference object, and the first reference text embedding vector (denoted as “TE1”) of the first reference object.

The processing circuitry 110 may similarly generate reference feature profiles using other images of the first reference object and images of other reference objects, generate the mapping between these reference feature profiles and corresponding object descriptors, and store the mapping in the object database 116. For example, as illustrated in FIG. 1, the object database 116 may be configured to store the mapping between the first descriptor (denoted as “OB1”) of the first reference object, a second reference feature vector (denoted as “FV2”) of the first reference object, a second reference image embedding vector (denoted as “IE2”) of the first reference object, and a second reference text embedding vector (denoted as “TE2”) of the first reference object. Further, the object database 116 may be configured to store the mapping between a second descriptor (denoted as “OB2”) of a second reference object, a third reference feature vector (denoted as “FV3”) of the second reference object, a third reference image embedding vector (denoted as “IE3”) of the second reference object, and a third reference text embedding vector (denoted as “TE3”) of the second reference object.

The object database 116 may thus include a plurality of reference feature profiles generated for a plurality of reference objects, with the plurality of reference feature profiles including two or more reference feature profiles generated for a same reference object and based on two or more images of the corresponding reference object, respectively. The object database 116 may be utilized for real-time object detection and recognition. The creation of such an object database 116, using a handful of images (e.g., five images) of each reference object (e.g., a few-shot method), eliminates the need for object detection and recognition models trained using large datasets of annotated data. The real-time object detection and recognition using the object database 116 is explained in detail below.

### Real-time object detection and recognition

As illustrated in FIG. 1, the rack 104 is in the FOV 108 of the camera 106. The camera 106 may thus be configured to capture an image of the rack 104. Each shelf of the rack 104 may include various objects (e.g., products). Examples of the products may include a food item, a beverage, a home essential, a kitchen essential, a personal care product, or the like. The processing circuitry 110 may be configured to receive the captured image from the camera 106.

The processing circuitry 110 may be further configured to obtain a prompt indicative of detection of a target object in the image. The environment 100 may further include a user device 118 that is coupled to the processing circuitry 110. The user device 118 may correspond to a cellphone, a laptop, a tablet, a phablet, a desktop, a computer, or the like. The user device 118 may be associated with a user (not shown). The user device 118 may include suitable logic, circuitry, interfaces, and/or code, executable by the circuitry, that may be configured to perform one or more operations for interacting with the processing circuitry 110. For example, the user device 118 may be used by the user to provide the prompt to the processing circuitry 110.

The prompt may include a description of the appearance of the target object. In an embodiment, the prompt may indicate at least one of a name, a type, a material, a dimension, one or more packaging details, or one or more manufacturing details of the target object. For example, if the target object corresponds to a cold drink can, the prompt may indicate a name (e.g., Coca-Cola^{®}), a type (e.g., can), a material (e.g., aluminum), a dimension (e.g., cylindrical), one or more packaging details (e.g., silver outer body and pull-tab lid), and one or more manufacturing details (e.g., Made in India). The prompt may thus be: “identify a cylindrical shaped Coca-Cola^{®} can, with a silver outer body and a pull-tab lid, which is made up of aluminum and which is made in India”. Thus, the more descriptive the prompt is, the higher the accuracy of object detection.

The processing circuitry 110 may be further configured to process the image based on the prompt to detect a target bounding box representing the target object present in the image. In an embodiment, the processing circuitry 110 processes the image using at least one of the execution models 112. For the detection of the target bounding box, the execution models 112 may include a prompt-based object detection model. In an example, the prompt-based object detection model may correspond to a grounding deformable implicit neural objects (DINO) model. The prompt-based object detection model is explained in detail in FIG. 2.

The processing circuitry 110 may thus be configured to detect, in the image, using the prompt-based object detection model, the target bounding box representing the target object present in the image. Based on the detected target bounding box, the processing circuitry 110 may be further configured to generate an object description indicative of an appearance of the target object. The processing circuitry 110 may generate the object description using at least one of the execution models 112. In such a scenario, the execution models 112 may include an image-to-text model. Based on the target bounding box and the object description, the processing circuitry 110 may be further configured to generate a current feature profile of the target object. The current feature profile may be indicative of a plurality of appearance characteristics of the target object.

In an embodiment, the processing circuitry 110 may be further configured to extract a set of visual features from the object description and generate a current feature vector that indicates the set of visual features of the target object. The set of visual features may include at least one of a color, a shape, one or more text labels, a packaging attribute, or a texture associated with the target object. However, in other embodiments, different visual features may be utilized. Further, the processing circuitry 110 may be configured to process the target bounding box using one of the execution models 112 to generate a current image embedding vector of the target object. In such a scenario, the execution models 112 may include an image feature extraction model. Further, the processing circuitry 110 may be configured to process the object description using one of the execution models 112 to generate a current text embedding vector of the target object. In such a scenario, the execution models 112 may include a text embedding model.

The current feature profile of the target object thus includes the current feature vector that indicates the set of visual features of the target object, the current image embedding vector generated using the target bounding box, and the current text embedding vector corresponding to a vector representation of the object description. The current feature vector may represent sparse features of the target object, whereas the current image embedding vector and the current text embedding vector may represent dense features of the target object.

The processing circuitry 110 may be further configured to compare the current feature profile of the target object with the plurality of reference feature profiles of the plurality of reference objects. The processing circuitry 110 may be further configured to access the storage element 114 to compare the current feature profile of the target object with the plurality of reference feature profiles of the plurality of reference objects stored in the object database 116. As described above, each reference feature profile includes a reference feature vector, a reference image embedding vector, and a reference text embedding vector generated for the corresponding reference object.

To compare the current feature profile of the target object with the first reference feature profile, of the plurality of reference feature profiles, representing the first reference object, of the plurality of reference objects, the processing circuitry 110 may execute various operations. For example, the processing circuitry 110 may be configured to compare the current feature vector associated with the target object with the first reference feature vector generated for the first reference object. Further, the processing circuitry 110 may be configured to compare the current image embedding vector associated with the target object with the first reference image embedding vector generated for the first reference object. Additionally, the processing circuitry 110 may be configured to compare the current text embedding vector associated with the target object with the first reference text embedding vector generated for the first reference object.

Based on the comparison of the current feature vector with the first reference feature vector, the processing circuitry 110 may be further configured to generate a first visual feature similarity score for the first reference feature profile. The first visual feature similarity score may be indicative of a similarity between the current feature vector associated with the target object and the first reference feature vector generated for the first reference object. The processing circuitry 110 may be further configured to assign a first weight to the visual feature similarity score.

In an embodiment, the first visual feature similarity score may be derived from individual visual features. For example, to generate the first visual feature similarity score, the processing circuitry 110 may be further configured to generate a set of intermediate scores, each intermediate score indicating a similarity between one visual feature associated with the target object and the first reference object, and assign a set of intermediate weights to the set of intermediate scores. In such a scenario, the first visual feature similarity score may be a function of each intermediate score of the set of intermediate scores and an intermediate weight, of the set of intermediate weights, assigned to the corresponding intermediate score. In an example, the sum of the set of intermediate weights is equal to one for the normalization of the first visual feature similarity score.

Based on the comparison of the current image embedding vector with the first reference image embedding vector, the processing circuitry 110 may be further configured to generate a first image embedding similarity score for the first reference feature profile. The first image embedding similarity score may be indicative of a similarity between the current image embedding vector associated with the target object and the first reference image embedding vector generated for the first reference object. The processing circuitry 110 may be further configured to assign a second weight to the first image embedding similarity score.

Based on the comparison of the current text embedding vector with the first reference text embedding vector, the processing circuitry 110 may be further configured to generate a first text embedding similarity score for the first reference feature profile. The first text embedding similarity score may be indicative of a similarity between the current text embedding vector associated with the target object and the first reference text embedding vector generated for the first reference object. The processing circuitry 110 may be further configured to assign a third weight to the first text embedding similarity score.

The processing circuitry 110 may be further configured to generate a first profile similarity score for the first reference feature profile. The first profile similarity score may be indicative of the similarity between the current feature profile and the first reference feature profile. In an embodiment, the first profile similarity score may be a function of the first visual feature similarity score, the first weight assigned to the first visual feature similarity score, the first image embedding similarity score, the second weight assigned to the first image embedding similarity score, the first text embedding similarity score, and the third weight assigned to the first text embedding similarity score. In an example, the sum of the first through third weights is equal to one for normalization of the first profile similarity score. The processing circuitry 110 may thus generate the first profile similarity score for the first reference feature profile based on the comparison of the current feature profile with the first reference feature profile.

The first through third weights indicate the contribution or importance of the first visual feature similarity score, the first image embedding similarity score, and the first text embedding similarity score, respectively, in the generation of the first profile similarity score. In an embodiment, the first through third weights may be different and remain static across input images. In another embodiment, the first through third weights may be equal and remain static across input images. In yet another embodiment, the first through third weights may be dynamic, and the processing circuitry 110 may assign the first through third weights based on the prompt. For example, if the prompt focuses on visual features, the first weight (e.g., the feature vector) is assigned a higher value than the second and third weights (e.g., the image and text embeddings). Conversely, if the prompt emphasizes specific attributes (e.g., “Find dark chocolate”), the second and third weights are increased. The set of intermediate weights may similarly be static or dynamic.

The processing circuitry 110 may be further configured to generate, based on the comparison of the current feature profile with the plurality of reference feature profiles, a plurality of profile similarity scores for the plurality of reference feature profiles, with each profile similarity score being generated in the manner similar to the generation of the first profile similarity score described above. Each profile similarity score, of the plurality of profile similarity scores, may thus be indicative of a similarity between the current feature profile and a corresponding reference feature profile of the plurality of reference feature profiles.

Based on the plurality of profile similarity scores of the plurality of reference feature profiles, the processing circuitry 110 may be further configured to select one of the plurality of reference objects that matches the target object. In an embodiment, the selected reference object is associated with the reference feature profile having the highest profile similarity score among the plurality of profile similarity scores. Thus, a similarity between the current feature profile of the target object and a reference feature profile of the selected reference object is within a desired range. In such a scenario, the desired range may correspond to a range of profile similarity scores that may indicate the reference objects being a match to the target object.

The processing circuitry 110 may be further configured to render a user interface (UI) representing the image, with the target bounding box. The target bounding box may be labeled with a descriptor associated with the selected reference object. In an embodiment, the processing circuitry 110 may render the UI on the user device 118.

The scope of the present disclosure is not limited to the selection of one of the plurality of reference objects in the manner described above. In numerous embodiments, the processing circuitry 110 may be configured to determine, based on the plurality of profile similarity scores, a set of reference feature profiles. The set of reference feature profiles is determined such that the profile similarity score of each of the set of reference feature profiles is within the desired range. In other words, from the plurality of reference objects, a set of reference objects is determined which are a likely match for the target object. A set of profile similarity scores associated with the set of reference feature profiles may indicate the degree of matching between the set of reference objects and the target object.

The processing circuitry 110 may be further configured to refine the set of profile similarity scores using at least one of the execution models 112. In such a scenario, the execution models 112 may include a cross-encoder re-ranking model. The cross-encoder re-ranking model is explained in detail in FIG. 2. Each of the set of profile similarity scores may be refined based on the prompt and a reference object description associated with the corresponding reference object. In other words, the set of profile similarity scores may be refined based on the prompt and a set of reference object descriptions associated with the set of reference objects represented by the set of reference feature profiles. The cross-encoder re-ranking mechanism refines object matching, ensuring that the final result is the most contextually relevant, improving the reliability of object detection where initial rankings might be prone to errors. In such a scenario, the selected reference object may be associated with the reference feature profile having the highest profile similarity score among the refined set of profile similarity scores.

In FIG. 1, the object detection and recognition technique is described for one target object to keep the description concise and clear. Matching reference objects for all target objects present in the image captured by the camera 106 may be identified in a similar manner as described above. Similarly, matching reference objects for all target objects present in images of different racks captured by different cameras of the retail store 102 may be identified in a similar manner as described above.

The object detection and recognition technique of the present disclosure may enable retailers to quickly identify products on shelves, verify planogram compliance, and facilitate seamless checkout experiences without needing vast amounts of pre-labeled data for every item in the retail store 102.

The scope of the present disclosure is not limited to the object detection and recognition in the retail store 102. In numerous embodiments, the object detection and recognition technique of the present disclosure may be implemented in any scenario where objects are to be detected and recognized in an automated manner. In one example, the object detection and recognition technique of the present disclosure may be implemented in surveillance systems used in public spaces like airports, train stations, shopping malls, and city streets for detecting and identifying objects of interest (e.g., bags, packages, or the like). The ability of the object detection and recognition technique to function with minimal training data makes it adaptable to new situations or threats. In another example, the object detection and recognition technique of the present disclosure may be implemented in warehouses and logistics centers. The use of visual, textual, and semantic features allows for efficient product recognition even with variations in packaging or product appearance, improving inventory management accuracy.

In yet another example, the object detection and recognition technique of the present disclosure may be implemented in medical imaging for identifying abnormalities, organs, or tools in clinical settings, particularly when combined with VLMs for more accurate and context-aware detection. In yet another example, the object detection and recognition technique of the present disclosure may be implemented in automated manufacturing and quality inspection to detect variations in product appearance or packaging, thereby ensuring that products meet predefined standards without extensive retraining for each new batch or product line. In yet another example, the object detection and recognition technique of the present disclosure may be implemented in augmented reality (AR) systems for real-time object identification, or in robotic systems where efficient and flexible object detection is required in changing environments, such as homes, hospitals, or customer service centers.

The object detection and recognition technique of the present disclosure may thus be executed based on the object database 116. In the present disclosure, the reference feature profiles, and in turn, the object database 116, are generated for various reference objects using a handful of images (e.g., five images) of each reference object. Additionally, during detection, the prompt-based bounding box detection approach eliminates the need for extensive iterative model training. Thus, the object detection and recognition technique of present disclosure may be executed without requiring vast amounts of annotated data. As a result, the object detection and recognition technique of the present disclosure is less labor-intensive and time-consuming as compared to conventional object detection and recognition models that are trained on vast amounts of labeled images. Consequently, the computational power utilized by the object detection and recognition technique of the present disclosure is also less as compared to the conventional object detection and recognition models. Further, the real-world deployment may be made quicker and more cost-effective. As vast amounts of labeled images are not required for effective operation, the object detection and recognition technique of the present disclosure is highly effective in dynamic environments like retail stores, warehouses, or the like. Additionally, modification or addition of new product classes does not necessitate any model retraining as only five images may be required to update the object database 116 for each new product class. This further saves significant computational power.

In the present disclosure, text embedding vectors and image embedding vectors are utilized, in addition to the feature vectors, for object detection and recognition. The detection accuracy of the object detection and recognition technique of the present disclosure is thus higher than the conventional object detection and recognition models that utilize only visual cues. Further, the use of more than just visual features ensures that the technique of the present disclosure may be implemented in varied settings (e.g., occlusion, change in illumination, background clutter, or the like). The accuracy may be further enhanced through the cross-encoder re-ranking mechanism, ensuring that the most contextually relevant product is selected from the top-ranked results. This refinement process may thus significantly improve object recognition, addressing a limitation often seen in conventional models that depend solely on initial ranking. These characteristics make the invention highly suitable for real-time applications, ensuring precise and efficient object identification in fast-paced environments.

The object detection and recognition technique of the present disclosure thus introduces a hybrid sparse-dense feature representation system that uses few-shot learning techniques. The object detection and recognition technique leverages VLMs, prompt-based bounding box detection, and image-to-text feature extraction to significantly reduce the amount of required training data. By incorporating sparse features (such as color, label, shape, and texture) alongside dense features (such as visual features, semantic descriptions, and text embeddings), the object detection and recognition technique of the present disclosure enhances product recognition with minimal image inputs. This hybrid approach improves both object identification and retrieval by combining low-level visual cues with high-level semantic understanding. In essence, the object detection and recognition technique of the present disclosure solves the technical challenge of reducing data dependency while maintaining high accuracy in object detection and product matching. The object detection and recognition technique of the present disclosure offers a more scalable and adaptive solution for environments where collecting large amounts of training data is impractical, enabling faster deployment and real-time recognition of products in changing contexts.

FIG. 2 is a block diagram of the processing circuitry 110, consistent with disclosed embodiments of the present disclosure. As illustrated in FIG. 2, the processing circuitry 110 may include a detector 202, a description generator 204, a profile manager 206, a score generator 208, an output controller 210, and a score refiner 212.

The detector 202 may be coupled to the camera 106 and the user device 118. The detector 202 may include suitable logic, circuitry, interfaces, and/or code, executable by the circuitry, that may be configured to perform one or more operations. For example, the detector 202 may be configured to receive the real-time image captured by the camera 106. The detector 202 may be further configured to obtain the prompt indicative of the detection of the target object in the image. Further, the detector 202 may be configured to process the image based on the prompt to detect the target bounding box representing the target object present in the image. In an embodiment, the detector 202 may be further configured to extract the target bounding box from the image and resize the extracted target bounding box for further processing.

The detector 202 may utilize a prompt-based object detection model 214 to detect the target bounding box for the target object present in the image. The prompt-based object detection model 214 is a type of ML model designed to identify and locate objects within an image or video. In an example, the prompt-based object detection model 214 may correspond to a grounding DINO model. The prompt-based object detection model 214 leverages natural language prompts to identify and localize target objects within the image by combining computer vision and natural language processing (NLP). The image and the prompt act as inputs, where the prompt specifies the object of interest, either explicitly (e.g., “Find all beverage cans in the image”) or descriptively (e.g., “Identify a coke can, made up of an aluminum outer packaging”). The image is processed using a deep-learning-based feature extractor, such as a convolutional neural network (CNN) or vision transformer, to generate the bounding boxes, while the prompt is encoded using a language model. These visual and textual features are then aligned using cross-attention mechanisms, allowing the prompt-based object detection model 214 to determine the relationship between the text description of the prompt and the target object in the image. Based on the determined relationship, the prompt-based object detection model 214 generates object proposals and predicts various bounding boxes. The bounding boxes are then filtered to eliminate irrelevant objects, and a final set of the target bounding boxes is outputted.

The description generator 204 may be coupled to the detector 202. The description generator 204 may include suitable logic, circuitry, interfaces, and/or code, executable by the circuitry, that may be configured to perform one or more operations. For example, the description generator 204 may be configured to receive bounding boxes (e.g., the target bounding box) from the detector 202. The description generator 204 may be configured to generate, based on the target bounding box, the object description indicative of the appearance of the target object. The description generator 204 may use an image-to-text model 216 to generate the object description.

The image-to-text model 216 is a type of AI system designed to analyze images and generate descriptive textual outputs. In an example, the image-to-text model 216 may correspond to Phi-3. The image-to-text model 216 typically combines computer vision techniques with NLP to interpret visual data and generate meaningful captions or textual representations. The image-to-text model 216 employs CNNs to extract features from images and transformer-based architectures, such as recurrent neural networks (RNNs) or attention mechanisms, to generate coherent text.

The profile manager 206 may be coupled to the detector 202 and the description generator 204. The profile manager 206 may include suitable logic, circuitry, interfaces, and/or code, executable by the circuitry, that may be configured to perform one or more operations. For example, the profile manager 206 may be configured to receive the object description from the description generator 204 and the target bounding box from the detector 202. Based on the target bounding box and the object description, the profile manager 206 may be configured to generate the current feature profile of the target object. The current feature profile may be indicative of a plurality of appearance characteristics of the target object.

In an embodiment, the profile manager 206 may be further configured to extract the set of visual features from the object description and generate the current feature vector that indicates the set of visual features of the target object. The set of visual features may include at least one of a color, a shape, one or more text labels, a packaging attribute, or a texture associated with the target object. However, in other embodiments, different visual features may be utilized.

The profile manager 206 may be further configured to process the target bounding box using an image feature extraction model 218 to generate the current image embedding vector of the target object. In an example, the image feature extraction model 218 may correspond to CLIP. The image feature extraction model 218 is an AI system designed to analyze images and identify important visual patterns, structures, and key elements. The image feature extraction model 218 processes the target bounding box through layers of a deep neural network to detect edges, textures, shapes, and more complex features. An image embedding vector (such as the current image embedding vector) is a numerical representation of images in a lower-dimensional space that captures their essential features and semantic meaning. The embedding vector may encode visual similarities, allowing images with similar content to have closer representations in the embedding space.

The profile manager 206 may be further configured to process the object description using a text embedding model 220 to generate the current text embedding vector of the target object. In an example, the text embedding model 220 may correspond to CLIP. The text embedding model 220 is a type of AI system that converts textual data into dense numerical vectors, capturing the semantic meaning and relationships between words, phrases, or entire documents. Text is mapped into a continuous vector space, where similar meanings are positioned closer together. A text embedding vector (such as the current text embedding vector) is a dense numerical representation of text in a multi-dimensional space, designed to capture semantic relationships and contextual meaning. Each word, phrase, or sentence is mapped to a fixed-size vector, where similar meanings have closer vector representations.

The current feature profile of the target object thus includes the current feature vector that indicates the set of visual features of the target object, the current image embedding vector generated using the target bounding box, and the current text embedding vector corresponding to a vector representation of the object description. The current feature vector may represent sparse features of the target object, whereas the current image embedding vector and the current text embedding vector may represent dense features of the target object.

The score generator 208 may be coupled to the storage element 114 and the profile manager 206. The score generator 208 may include suitable logic, circuitry, interfaces, and/or code, executable by the circuitry, that may be configured to perform one or more operations. For example, the score generator 208 may be configured to access the object database 116 and retrieve the plurality of reference feature profiles of the plurality of reference objects. Each of the plurality of reference feature profiles may be generated by the profile manager 206, in conjunction with the detector 202 and the description generator 204, in a manner similar to the generation of the current feature profile described above. The generation of the plurality of reference feature profiles is not described in FIG. 2 to keep the description concise and clear, and should not be considered a limitation of the present disclosure.

The score generator 208 may be further configured to compare the current feature profile of the target object with the plurality of reference feature profiles of the plurality of reference objects. Each reference feature profile includes a reference feature vector, a reference image embedding vector, and a reference text embedding vector generated for the corresponding reference object. Thus, the comparison of the current feature profile with the first reference feature profile corresponds to comparison of (i) the current feature vector associated with the target object with the first reference feature vector generated for the first reference object, (ii) the current image embedding vector associated with the target object with the first reference image embedding vector generated for the first reference object, and (iii) the current text embedding vector associated with the target object with the first reference text embedding vector generated for the first reference object.

Based on the comparison of the current feature vector with the first reference feature vector, the score generator 208 may be further configured to generate the first visual feature similarity score for the first reference feature profile. The score generator 208 may be further configured to assign the first weight to the visual feature similarity score. In an embodiment, the first visual feature similarity score may be derived from individual visual features. For example, to generate the first visual feature similarity score, the score generator 208 may be further configured to generate the set of intermediate scores, each intermediate score indicating a similarity between one visual feature associated with the target object and the first reference object, and assign the set of intermediate weights to the set of intermediate scores. In such a scenario, the first visual feature similarity score may be a function of each intermediate score of the set of intermediate scores and an intermediate weight, of the set of intermediate weights, assigned to the corresponding intermediate score.

Based on the comparison of the current image embedding vector with the first reference image embedding vector, the score generator 208 may be further configured to generate the first image embedding similarity score for the first reference feature profile. The score generator 208 may be further configured to assign the second weight to the first image embedding similarity score. Further, based on the comparison of the current text embedding vector with the first reference text embedding vector, the score generator 208 may be configured to generate the first text embedding similarity score for the first reference feature profile. The score generator 208 may be further configured to assign the third weight to the first text embedding similarity score.

The score generator 208 may be further configured to generate the first profile similarity score for the first reference feature profile. In an embodiment, the first profile similarity score may be a function of the first visual feature similarity score, the first weight assigned to the first visual feature similarity score, the first image embedding similarity score, the second weight assigned to the first image embedding similarity score, the first text embedding similarity score, and the third weight assigned to the first text embedding similarity score. The score generator 208 may be further configured to generate, based on the comparison of the current feature profile with the plurality of reference feature profiles, the plurality of profile similarity scores for the plurality of reference feature profiles, with each profile similarity score being generated in the manner similar to the generation of the first profile similarity score described above.

The output controller 210 may be coupled to the score generator 208, the storage element 114, the score refiner 212, and the user device 118. The output controller 210 may include suitable logic, circuitry, interfaces, and/or code, executable by the circuitry, that may be configured to perform one or more operations. For example, the output controller 210 may be configured to receive the plurality of profile similarity scores from the score generator 208.

Based on the plurality of profile similarity scores of the plurality of reference feature profiles, the output controller 210 may be further configured to select one of the plurality of reference objects that matches the target object. In an embodiment, the selected reference object is associated with the reference feature profile having the highest profile similarity score among the plurality of profile similarity scores. The score generator 208 may be further configured to access the object database 116 and retrieve the plurality of descriptors of the plurality of reference objects. The output controller 210 may be further configured to render the UI representing the image, with the target bounding box labeled with a descriptor associated with the selected reference object. In an embodiment, the output controller 210 may render the UI on the user device 118.

The scope of the present disclosure is not limited to the selection of one of the plurality of reference objects in the manner described above. In numerous embodiments, the output controller 210 may be configured to determine, based on the plurality of profile similarity scores, the set of reference feature profiles. The set of reference feature profiles is determined such that the profile similarity score of each of the set of reference feature profiles is within the desired range. In other words, from the plurality of reference objects, the set of reference objects are determined which are a likely match for the target object. The set of profile similarity scores associated with the set of reference feature profiles may indicate the degree of matching between the set of reference objects and the target object. The output controller 210 may be further configured to provide the set of set of profile similarity scores to the score refiner 212.

The score refiner 212 may be coupled to the output controller 210 and the user device 118. The score refiner 212 may include suitable logic, circuitry, interfaces, and/or code, executable by the circuitry, that may be configured to perform one or more operations. For example, the score refiner 212 may be configured to receive the set of profile similarity scores from the output controller 210, and the prompt from the user device 118. The score refiner 212 may be further configured to refine the set of profile similarity scores based on the prompt and the set of reference object descriptions associated with the set of reference objects represented by the set of reference feature profiles. In an embodiment, the object database 116 may further store the reference object descriptions generated for each reference object, and the set of reference object descriptions associated with the set of reference objects may be retrieved from the object database 116.

The score refiner 212 may refine each profile similarity score using a cross-encoder re-ranking model 222. The cross-encoder re-ranking model 222 employs a deep learning-based approach used to refine and reorder a set of candidate text passages based on their relevance to a given query. Unlike bi-encoder models that independently encode queries and documents into separate vector spaces, a cross-encoder processes both the query and the candidate passage together, typically using transformer-based architectures. The cross-encoder re-ranking model 222 may jointly attend to the input pair, enabling deeper contextual interactions and producing a relevance score for each candidate. This approach significantly improves ranking accuracy by capturing finer-grained relationships between queries and documents. Examples of such models include monolithic bi-directional encoder representations from transformers (MonoBERT), a monolithic text-to-text transfer transformer (MonoT5), and a ranking text-to-text transfer transformer (RankT5).

The output controller 210 may be further configured to receive, from the score refiner 212, the refined set of profile similarity scores. Based on the refined set of profile similarity scores, the output controller 210 may be further configured to select one of the set of reference objects that matches the target object. In an embodiment, the selected reference object is associated with the reference feature profile having the highest profile similarity score among the refined set of profile similarity scores.

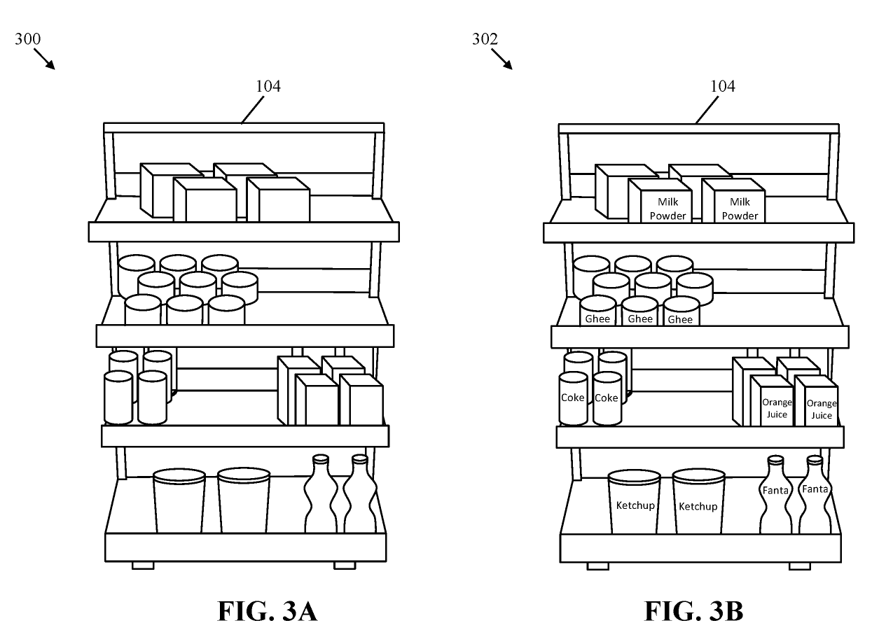

FIG. 3A and 3B, collectively, represents an example scenario of the object detection and recognition technique, consistent with disclosed embodiments of the present disclosure. FIG. 3A represents an image 300 captured by the camera 106. The image 300 may present the rack 104 and various products displayed on the rack 104. As illustrated in FIG. 3A, various products are visible on the rack 104. The products are arranged on various shelves, with some products of similar shapes arranged together.

In such a scenario, the prompt may be as follows:

“Identify and locate the following product packaging types:

Cartons: almond milk boxes, tea boxes, orange juice tetra packs

PET bottles: Fanta bottles,

Cans: Coca-Cola^{®} cans,

Plastic bottles: ghee bottles, ketchup bottles.

For each item: Draw a bounding box around the product, Label it with the product name and packaging type, and Identify multiple instances of the same product where applicable.

Also identify: Any visible product logos or brand names" .

The object detection and recognition technique of the present disclosure may be implemented using this descriptive prompt.

FIG. 3B represents an output 302 of the object detection and recognition technique implemented on the image 300. The output 302 may correspond to the UI that represents the image 300, with the products (e.g., bounding boxes that are not shown to keep the illustration concise and clear) labeled with a descriptor associated with matching reference objects. Descriptors for some products are illustrated in FIG. 3B. For example, the products on the upper shelf are milk powders, whereas those on the second shelf are ghee bottles. Similarly, the third shelf stores coke cans and orange juice tetra packs, whereas the bottom shelf stores ketchup bottles and cold drink bottles of the brand ‘Fanta’. The object detection and recognition technique of the present disclosure thus enables efficient and effective detection and recognition of various objects present in an image.

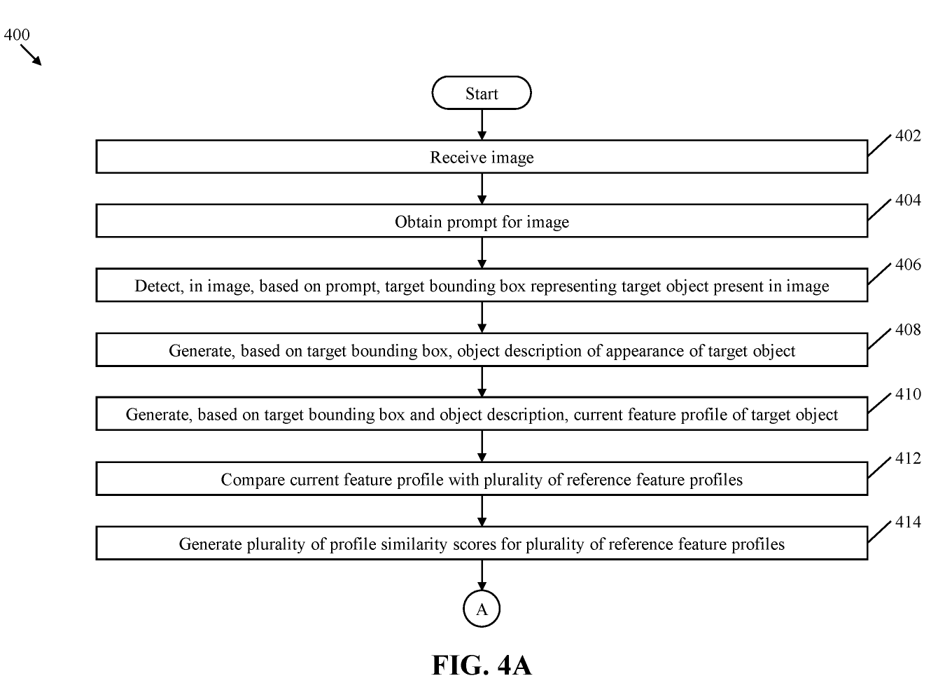

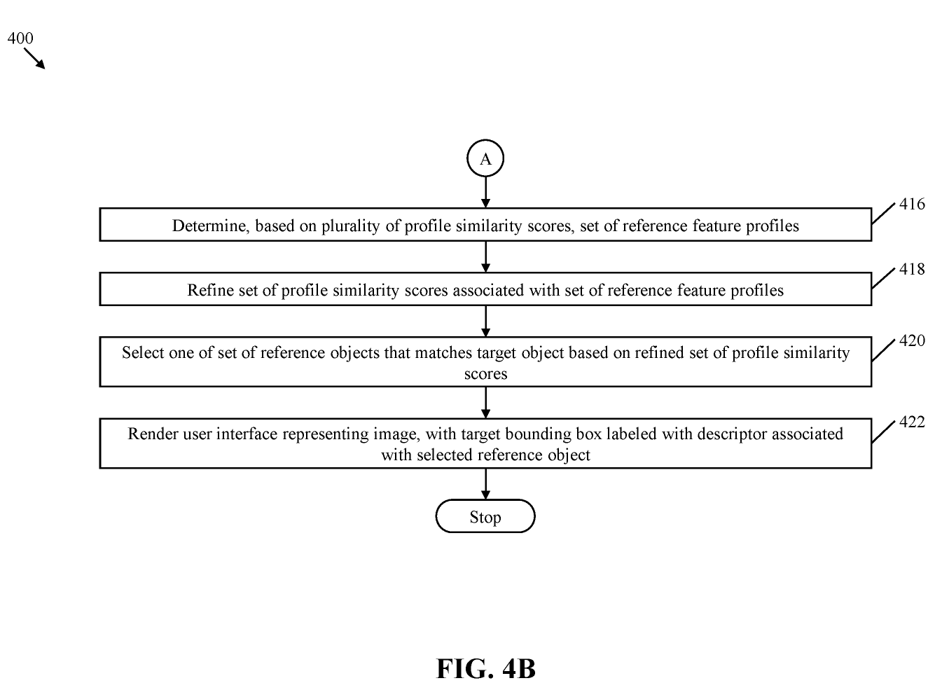

FIGS. 4A and 4B, collectively, represents a flowchart 400 that illustrates a method for object detection and recognition, consistent with disclosed embodiments of the present disclosure.

Referring to FIG. 4A, at 402, the processing circuitry 110 may receive an image. The image may be of the rack 104. At 404, the processing circuitry 110 may obtain a prompt for the image. The prompt may include a description of the appearance of an object to be detected in the image. In an embodiment, the prompt may indicate at least one of a name, a type, a material, a dimension, one or more packaging details, or one or more manufacturing details of the object. At 406, the processing circuitry 110 may detect, in the image, based on the prompt, a target bounding box representing a target object present in the image. The target bounding box may be detected using the prompt-based object detection model 214.

At 408, the processing circuitry 110 may generate, based on the target bounding box, an object description of an appearance of the target object. The object description may be generated using the image-to-text model 216. At 410, the processing circuitry 110 may generate, based on the target bounding box and the object description, a current feature profile of the target object. The current feature profile may be indicative of a plurality of appearance characteristics of the target object. In an embodiment, the current feature profile of the target object may include a current feature vector that indicates a set of visual features of the target object, a current image embedding vector generated using the target bounding box, and a current text embedding vector corresponding to a vector representation of the object description.

At 412, the processing circuitry 110 may compare the current feature profile with a plurality of reference feature profiles. The plurality of reference feature profiles may be associated with a plurality of reference objects that are likely to be a match for the target object. At 414, the processing circuitry 110 may generate a plurality of profile similarity scores for the plurality of reference feature profiles. Each profile similarity score, of the plurality of profile similarity scores, may be indicative of a similarity between the current feature profile and a corresponding reference feature profile of the plurality of reference feature profiles. In an embodiment, each profile similarity score may be a function of similarities between the visual features, image embeddings, and text embeddings of the current feature profile and the corresponding reference feature profile and the weights assigned to the visual features, the image embeddings, and the text embeddings.

Referring to FIG. 4B, at 416, the processing circuitry 110 may determine, based on the plurality of profile similarity scores, a set of reference feature profiles. The set of reference feature profiles is determined such that the profile similarity score of each of the set of reference feature profiles is within the desired range. In other words, from the plurality of reference objects, a set of reference objects is determined, each of which is a likely match for the target object. A set of profile similarity scores associated with the set of reference feature profiles may indicate the degree of matching between the set of reference objects and the target object.

At 418, the processing circuitry 110 may refine the set of profile similarity scores associated with the set of reference feature profiles. The set of profile similarity scores is refined using the cross-encoder re-ranking model 222. Each of the set of profile similarity scores may be refined based on the prompt and a reference object description associated with the corresponding reference object. At 420, the processing circuitry 110 may select one of the set of reference objects that matches the target object based on the refined set of profile similarity scores. In an embodiment, the selected reference object is associated with the reference feature profile having the highest profile similarity score among the refined set of profile similarity scores. At 422, the processing circuitry 110 may render a UI representing the image, with the target bounding box labeled with the descriptor associated with the selected reference object. The UI may be rendered on the user device 118.

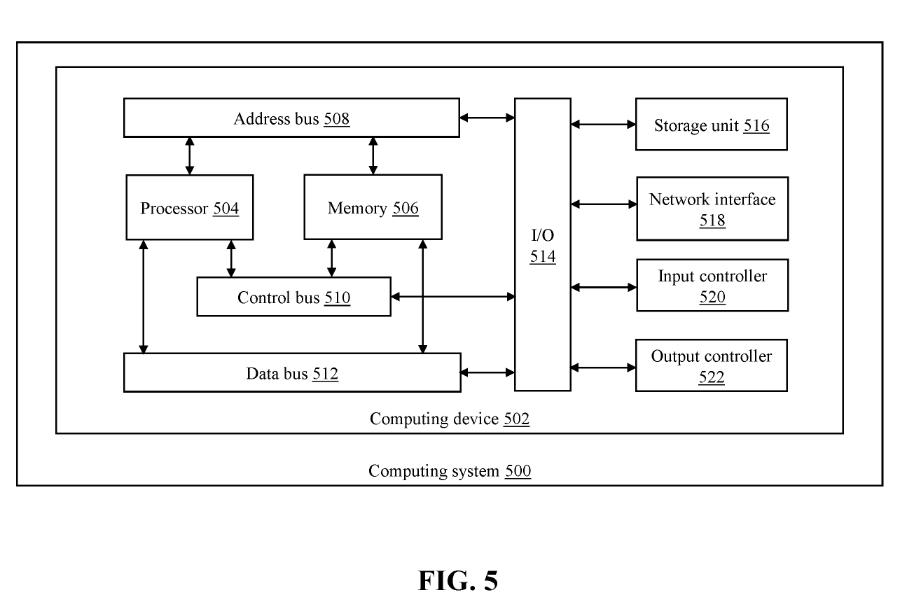

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 may be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art will recognize that the memory 506 may be separate from the computing device 502.

The memory 506 may store information that may be accessed by the processor 504. For instance, the memory 506 (e.g., one or more non-transitory computer-readable storage mediums, memory devices) may include computer-readable instructions (not shown) that may be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that may be obtained, received, accessed, written, manipulated, created, and/or stored. The data may include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 516 is a transitory computer-readable medium. The storage unit 516 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive images and prompts. The output controller 522 may include suitable logic, circuitry, interfaces, and/or code, executable by the circuitry, that may be configured to control one or more output devices that may be configured to output UIs.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for object detection and recognition using visual, textual, and semantic features. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry configured to:
detect, in an image, using a prompt-based object detection model, a target bounding box that represents a target object present in the image;
generate, based on the target bounding box, using an image-to-text model, an object description indicative of an appearance of the target object;
generate, based on the target bounding box and the object description, a current feature profile of the target object, wherein the current feature profile is indicative of a plurality of appearance characteristics of the target object;
compare the current feature profile of the target object with a plurality of reference feature profiles of a plurality of reference objects; and
select one of the plurality of reference objects that matches the target object, wherein a similarity between the current feature profile of the target object and a reference feature profile of the selected reference object is within a desired range.

2. The system of claim 1, wherein to detect the target bounding box in the image, the processing circuitry is further configured to:
receive the image;
obtain a prompt indicative of the detection of the target object in the image; and
process, using the prompt-based object detection model, the image based on the prompt to detect the target bounding box.

3. The system of claim 2, wherein the prompt indicates at least one of: a name, a type, a material, a dimension, one or more packaging details, or one or more manufacturing details of the target object.

4. The system of claim 1, wherein the current feature profile of the target object comprises at least one of:
a feature vector that indicates a set of visual features of the target object,
an image embedding vector generated using the target bounding box, and
a text embedding vector corresponding to a vector representation of the object description.

5. The system of claim 4, wherein the processing circuitry is further configured to extract the set of visual features from the object description, and wherein the set of visual features comprises at least one of a color, a shape, one or more text labels, a packaging attribute, or a texture associated with the target object.

6. The system of claim 4, wherein the processing circuitry is further configured to process the target bounding box using an image feature extraction model to generate the image embedding vector.

7. The system of claim 4, wherein the processing circuitry is further configured to process the object description using a text embedding model to generate the text embedding vector.

8. The system of claim 4, wherein to compare the current feature profile of the target object with a first reference feature profile, of the plurality of reference feature profiles, representing a first reference object, of the plurality of reference objects, the processing circuitry is further configured to:
compare the feature vector associated with the target object with another feature vector generated for the first reference object;
compare the image embedding vector associated with the target object with another image embedding vector generated for the first reference object; and
compare the text embedding vector associated with the target object with another text embedding vector generated for the first reference object.

9. The system of claim 8,
wherein based on the comparison of the current feature profile with the first reference feature profile, the processing circuitry is further configured to generate a profile similarity score for the first reference feature profile of the first reference object,
wherein the profile similarity score is indicative of the similarity between the current feature profile and the first reference feature profile, and
wherein the processing circuitry selects one of the plurality of reference objects that matches the target object based on a plurality of profile similarity scores of the plurality of reference feature profiles.

10. The system of claim 9, wherein to generate the profile similarity score, the processing circuitry is further configured to:
generate a visual feature similarity score indicative of a similarity between the feature vector associated with the target object and the feature vector generated for the first reference object;
generate an image embedding similarity score indicative of a similarity between the image embedding vector associated with the target object and the image embedding vector generated for the first reference object;
generate a text embedding similarity score indicative of a similarity between the text embedding vector associated with the target object and the text embedding vector generated for the first reference object; and
assign a weight to each of the visual feature similarity score, the image embedding similarity score, and the text embedding similarity score, wherein the profile similarity score is a function of (i) the visual feature similarity score, (ii) the weight assigned to the visual feature similarity score, (iii) the image embedding similarity score, (iv) the weight assigned to the image embedding similarity score, (v) the text embedding similarity score, and (vi) the weight assigned to the text embedding similarity score.

11. The system of claim 10, wherein the processing circuitry detects the target bounding box based on a prompt, and wherein the processing circuitry assigns the weight to each of the visual feature similarity score, the image embedding similarity score, and the text embedding similarity score based on the prompt.

12. The system of claim 10, wherein the weight assigned to each of the visual feature similarity score, the image embedding similarity score, and the text embedding similarity score is static.

13. The system of claim 10,
wherein to generate the visual feature similarity score, the processing circuitry is further configured to (i) generate a set of intermediate scores, each intermediate score indicating a similarity between one visual feature associated with the target object and the first reference object, and (ii) assign a set of intermediate weights to the set of intermediate scores, and
wherein the visual feature similarity score is a function of (i) each intermediate score of the set of intermediate scores and (ii) an intermediate weight, of the set of intermediate weights, assigned to the corresponding intermediate score.

14. The system of claim 1, further comprising a storage element configured to store a database,
wherein the database includes a mapping between (i) a descriptor of each of the plurality of reference objects and (ii) a reference feature profile, of the plurality of reference feature profiles, generated for the corresponding reference object of the plurality of reference objects, and
wherein the processing circuitry is coupled to the storage element, and configured to access the storage element to compare the current feature profile of the target object with the plurality of reference feature profiles of the plurality of reference objects.

15. The system of claim 1,
wherein the processing circuitry is further configured to generate, based on the comparison of the current feature profile with the plurality of reference feature profiles, a plurality of profile similarity scores for the plurality of reference feature profiles,
wherein each profile similarity score, of the plurality of profile similarity scores, is indicative of a similarity between the current feature profile and a corresponding reference feature profile of the plurality of reference feature profiles, and
wherein the selected reference object is associated with the reference feature profile having the highest profile similarity score among the plurality of profile similarity scores.

16. The system of claim 15, wherein the processing circuitry is further configured to:
determine, based on the plurality of profile similarity scores, a set of reference feature profiles, wherein the profile similarity score of each of the set of reference feature profiles is within the desired range; and
refine a set of profile similarity scores associated with the set of reference feature profiles based on (i) a prompt using which the target bounding box is detected and (ii) a set of reference object descriptions associated with a set of reference objects represented by the set of reference feature profiles, wherein the selected reference object is associated with the reference feature profile having the highest profile similarity score among the refined set of profile similarity scores.

17. The system of claim 16, wherein the processing circuitry refines each of the set of profile similarity scores using a cross-encoder re-ranking model.

18. The system of claim 1, wherein the processing circuitry is further configured to render a user interface representing the image, with the target bounding box, and wherein the target bounding box is labeled with a descriptor associated with the selected reference object.

19. The system of claim 1, wherein the plurality of reference feature profiles include two or more reference feature profiles generated for a same reference object, with the two or more reference feature profiles generated based on two or more images of the corresponding reference object, respectively.

20. A method, comprising:
detecting, by processing circuitry, in an image, using a prompt-based object detection model, a target bounding box that represents a target object present in the image;
generating, by the processing circuitry, based on the target bounding box, using an image-to-text model, an object description indicative of an appearance of the target object;
generating, by the processing circuitry, based on the target bounding box and the object description, a current feature profile of the target object, wherein the current feature profile is indicative of a plurality of appearance characteristics of the target object;
comparing, by the processing circuitry, the current feature profile of the target object with a plurality of reference feature profiles of a plurality of reference objects; and
selecting, by the processing circuitry, one of the plurality of reference objects that matches the target object, wherein a similarity between the current feature profile of the target object and a reference feature profile of the selected reference object is within a desired range.
